(19) United States
(12) Patent Application Publication
(10) Pub. No.: US 2005/0204890 A1
(43) Pub. Date: Sep. 22, 2005

(54) Friction free grand piano action

(76) Inventor: Richard Wroblewski, Trumbull, CT (US)

Correspondence Address: Richard Wroblewski, 701 Silver Lane, Trumbulll, CT, 06611, US

(21) Appl. No.: 10/801,668

(22) Filed: Mar. 17, 2004

(51) Int. Cl. G10C 3/18

(52) U.S. Cl. 84/236

(57) ABSTRACT

A grand piano action including a jack spring turning inert during the jack escaping from the knuckle friction free.

### FIELD OF THE INVENTION

The present invention relates to grand pianos affected by excessive friction between the knuckle dependent from the shank carrying the piano hammer and the lifting surface of the jack lifting the knuckle.

### BACKGROUND OF THE INVENTION

Conventional grand pianos are plagued by excessive friction between the knuckle and the lifting surface of the jack causing noise requiring frequent regulation with lubricant being applied to the knuckle and the lifting surface of the jack to reduce the excessive friction. Friction is caused by gravity of the hammer assembly, and made excessive by the jack spring being in a fixed constant tension exerting pressure upon the jack and the wippen lever.

### SUMMARY OF THE INVENTION

In the present invention the jack spring is relocated making it possible to disable the jack spring during disengagement of the jack from the knuckle, thereby eliminating the excessive friction caused by the fixed constant tension of the jack spring exerting pressure upon the jack and the wippen lever.

### DESCRIPTION OF THE PREFERRED EMBODIMENTS

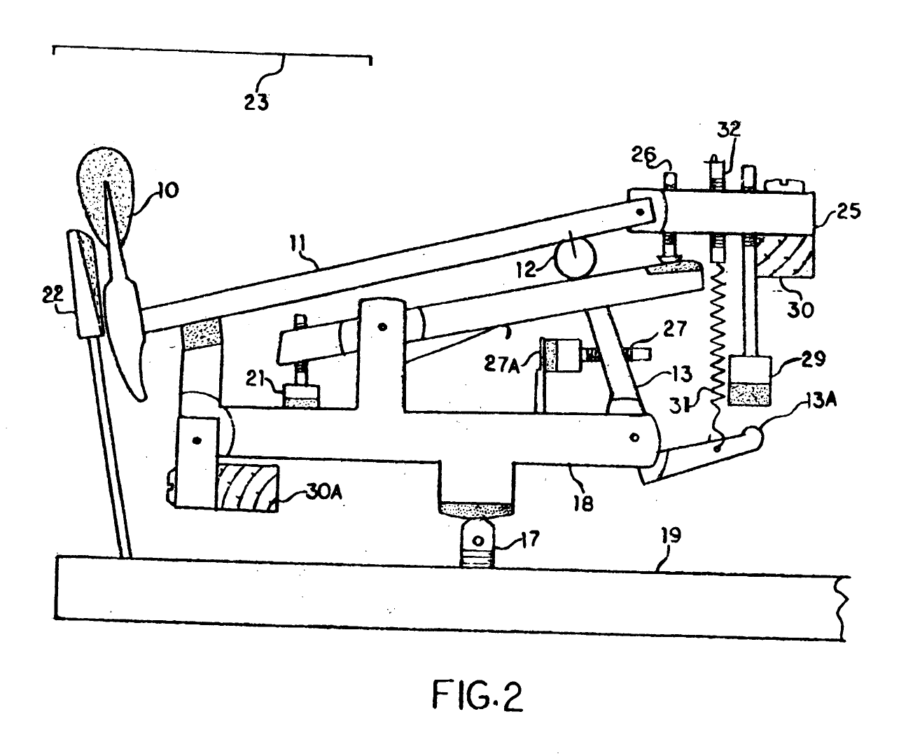

FIG. 2 shows the arm 13A of the jack 13 being supported by the spiral spring 31 dependent from the regulating screw 32 carried by the flange 25; the regulating screw regulate the spiral spring to an appropriate tension, a higher tension would cause the jack to rise; the upward movement of the jack along with the spiral spring causing the spiral spring to be shortened effecting the spiral spring inert, disabled, causing the jack to escape from the knuckle 12 easily by a very light piano key 19 affected by absence of the traditional excessive friction between the knuckle 12, and the lifting surface of the jack 13, when the arm 13A of the jack 13 hits the escapement let off button 29.

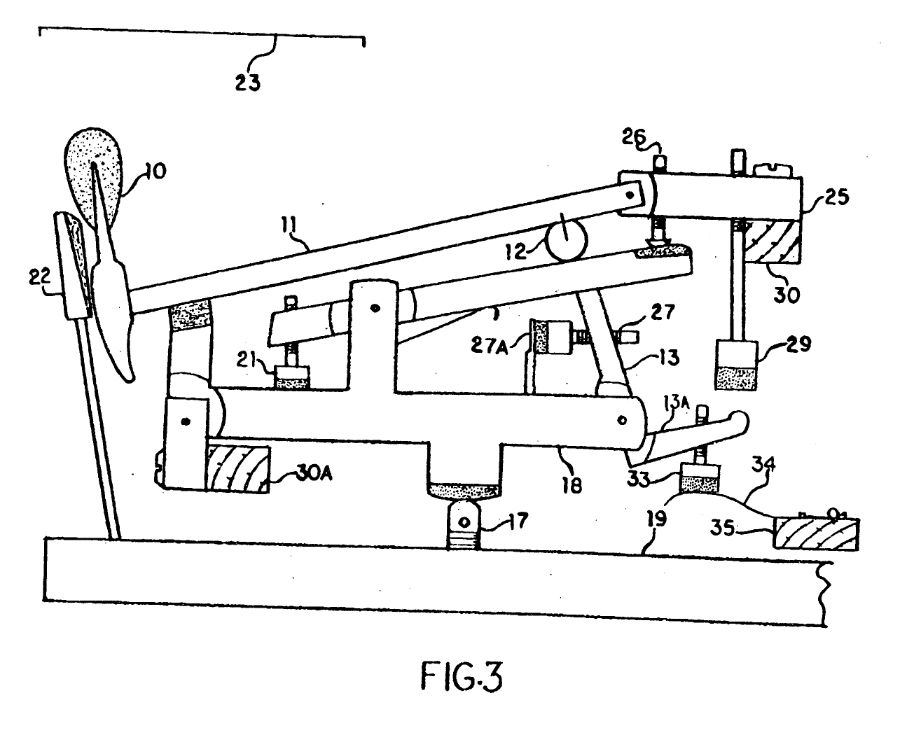

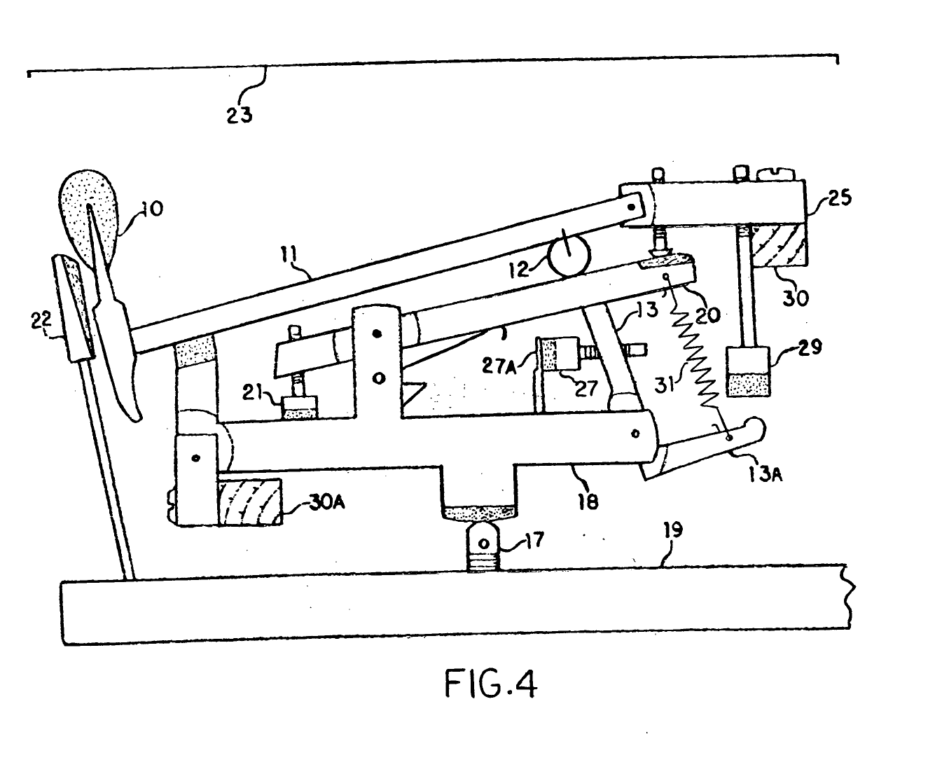

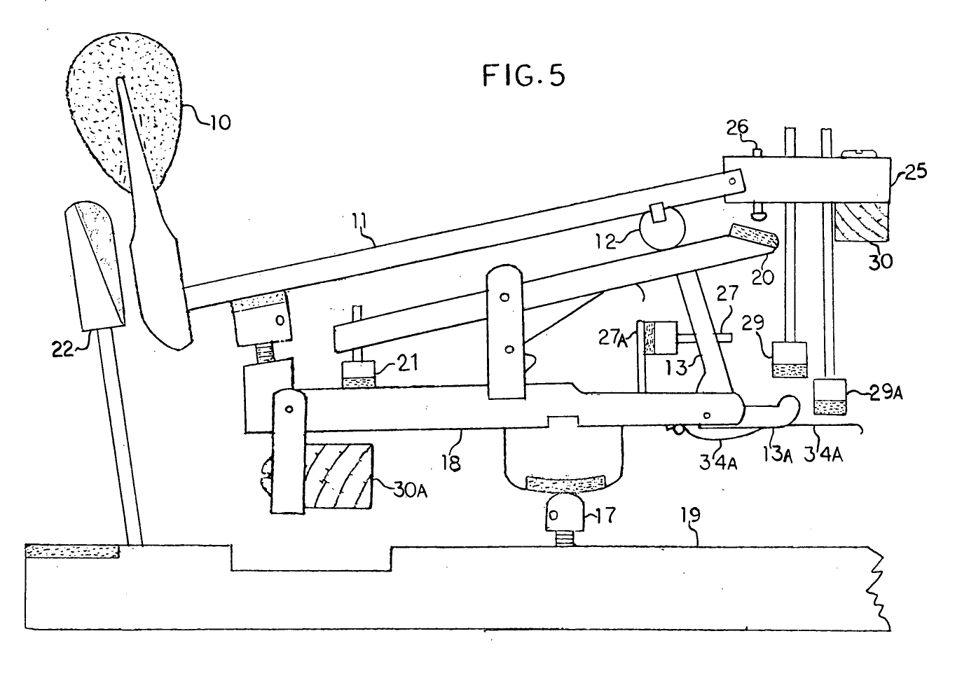

FIG. 3 shows the arm 13A carrying a regulating button 33 resting on a spring 34 carried by a rail 35, the upward movement of the arm 13A effecting the spring 34 carried by the rail 35, to rise in contact with the regulating button 33, effecting the spring 34 inert, disabled, causing the jack to escape from the knuckle without the traditional excessive friction, when the arm of said jack hits the escapement let off button.

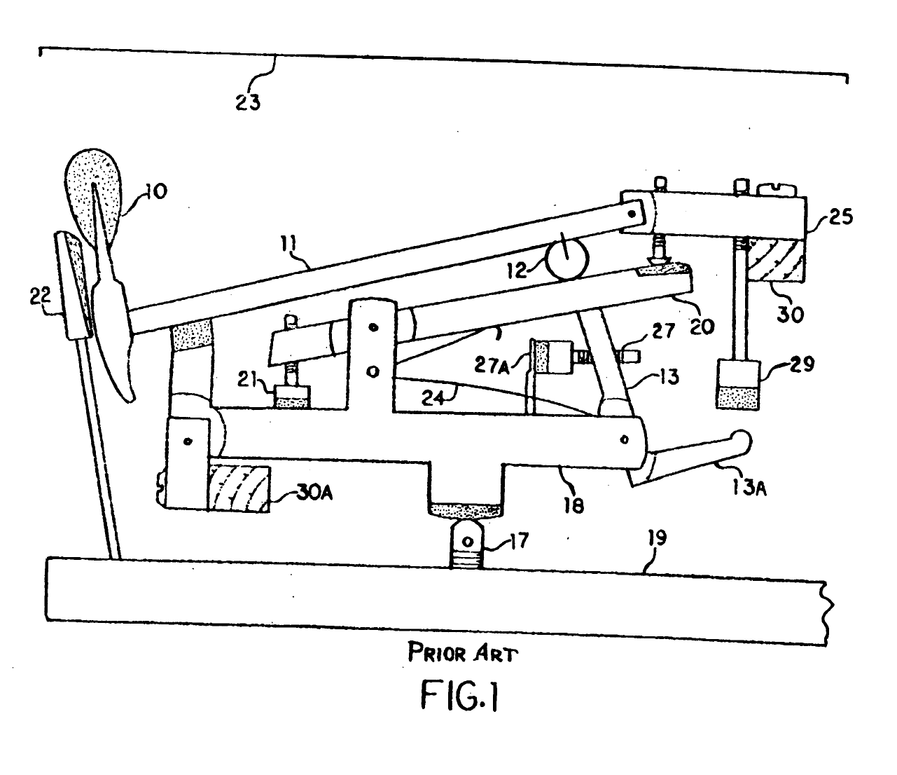

### REFERENCE NUMERALS FIGS. 1-3

10 piano hammer

11 hammer shank

12 knuckle

13 jack

13A arm of jack

14 jack center pin

17 capstan

18 wippen lever

19 piano key

20 repetition lever

21 regulating button

22 back check

23 string

24 jack spring

25 flange

26 regulating drop screw

27 regulating button

27A spoon

29 escapement let off button

30 rail

31 spiral jack spring

32 regulating screw

33 regulating button

34 jack spring

35 rail

1. A grand piano action comprising a flange carrying a hammer shank carrying a piano hammer and a knuckle; a wippen lever carrying a jack; said jack having an arm; said wippen lever being supported by a capstan on a piano key; said piano key carrying a hammer back check; said arm of said jack including an elastic means being connected to said flange; the lifting surface of said jack being in contact with said knuckle; upon depressing said piano key said jack being lifted along with said elastic means shortening said elastic means into a relaxed disabled state; said lifting surface of said jack escaping from said knuckle when said arm of said jack hitting the escapement let off button.

2. The grand piano action according to claim 1 wherein said elastic means being dependent from a regulating screw carried by said flange.

3. A grand piano action comprising a flange carrying a hammer shank carrying a piano hammer and a knuckle; a wippen lever carrying a jack; said jack having an arm; said wippen lever being supported by a capstan on a piano key; said piano key carrying a hammer back check; said arm of said jack including a convoluted spring means being connected to said flange; the lifting surface of said jack being in contact with said knuckle; upon depressing said piano key said jack being lifted along with said convoluted spring means shortening said convoluted spring means into a relaxed disabled state; said lifting surface of said jack escaping from said knuckle when said arm of said jack hitting the escapement let off button.

4. The grand piano action according to claim 3 wherein said convoluted spring means being dependent from a regulating screw carried by said flange; the first end of said convoluted spring means being in a hole along said regulating screw; the very end being bent over the end of said regulating screw; the other end being hooked onto said arm of said jack.

5. A grand piano action comprising a flange carrying a hammer shank carrying a piano hammer and a knuckle; a wippen lever carrying a jack, said jack having an arm; said arm opposing an escapement let off button; said wippen lever being supported by a capstan on a piano key, said piano key carrying a hammer back check; a spring means being carried by a rail, said spring means supporting said arm of said jack; a lifting surface of said jack being in contact with said knuckle; upon depressing said piano key said arm of said jack being lifted together with said spring means effecting said spring means to turn inert, permitting said lifting surface of said jack to escape from said knuckle with ease during said arm of said jack hitting said escapement let off button.

6. The grand piano action according to claim 5 wherein said arm of said jack carrying a regulating button resting on said spring means carried by said rail.

7. The grand piano action according to claim 1 wherein said arm of said jack including said elastic means connected to said flange being a band, said arm of said jack being inside of said band.

8. The grand piano action according to claim 2 wherein said elastic means depending from said regulating screw carried by said flange being a band depending from a wire being in a hole along said regulating screw, the end of said wire being bent over said regulating screw, the arm of the jack being inside of said band.

9. The grand piano action according to claim 4 wherein said first end of said convoluted spring means in said hole along said regulating screw extending along said hole being straight.

10. The grand piano action according to claim 4 wherein said convoluted spring means being of a substantially light gauge.

11. The grand piano action according to claim 8 wherein said band being made of rubber.

12. The grand piano action according to claim 8 wherein said band being made of resilient plastic.

13. The grand piano action according to claim 5 wherein said spring means carried by said rail being in a groove under said arm of said jack supporting said jack.

14. The grand piano action according to claim 1 wherein said arm of said jack including said elastic means being connected to the repetition lever supporting said knuckle carried by said hammer shank.

15. The grand piano action according to claim 3 wherein said arm of said jack including said convoluted spring means being connected to the repetition lever supporting said knuckle carried by said hammer shank.

16. The grand piano action according to claim 15 wherein said arm of said jack including a regulating screw, said convoluted soring means connected to said repetition lever connecting to said regulating screw.

17. The grand piano action according to claim 14 wherein said elastic means being a band stretched about the end of said repetition lever and about said arm of said jack.

18. The grand piano action according to claim 17 wherein said band being attached to said repetition lever, said arm of said jack being inside of said band.

19. The grand piano action according to claim 17 wherein said band being made of rubber.

20. The grand piano action according to claim 17 wherein said band being made of resilient plastic.

21. In a traditional grand piano action wherein a resilient means dependent from above supporting the arm of the jack to eliminate the excessive friction at the jack and knuckle interface.

22. In a traditional grand piano action wherein a resilient means below the arm of the jack positioned on a stationary member supporting said arm of said jack to eliminate the excessive friction at the jack and knuckle interface.

23. The grand piano action according to claim 1 wherein said flange including a band formed of a convoluted spring means; said arm of said jack being inside of said band supporting said jack.

24. The grand piano action according to claim 23 wherein said flange further including a regulating screw having a hole along said regulating screw; a wire inside said hole having both ends bent, one end carrying said band formed of said convoluted spring means enveloping said arm of said jack supporting said jack.

25. The grand piano action according to claim 9 wherein said first end of said convoluted spring means in said hole along said regulating screw extending along said hole being straight; the diameter of the coils of said convoluted spring means being substantially greater than the diameter of said regulating screw.

26. The grand piano action according to claim 4 wherein said first end of said convoluted spring means being in a depression around said regulating screw, said other end of said convoluted spring means being hooked onto said arm of said jack.

27. The grand piano action according to claim 1 wherein said wippen lever including a spring means supporting the undersurface of said arm, the end of said spring means opposing a regulating button; said arm opposing said escapement let off button.
